(19) United States
(12) Patent Application Publication
(10) Pub. No.: US 2026/0117552 A1
(43) Pub. Date: Apr. 30, 2026

(54) LOCKING HANDLE MECHANISM FOR WINDOWS

(71) Applicant: FERCO FERRURES DE BATIMENTS INC., Laval (CA)

(72) Inventors: Maxime ÉMARD, Montreal (CA); Jeremy LA SALLE-PIKE, Montreal (CA); Yannick GOLAY, Montreal (CA)

(21) Appl. No.: 19/374,047

(22) Filed: Oct. 30, 2025

Related U.S. Application Data
(60) Provisional application No. 63/713,736, filed on Oct. 30, 2024.

(51) Int. Cl. E05B 5/00; E05C 1/00

(52) U.S. Cl. CPC E05B 5/006; E05C 1/006

(57) ABSTRACT

A locking mechanism for a window/door having a frame and a sash, has: a housing assembly configured to be received in an opening defined by one of the frame and the window/door sash, the housing assembly having a frontal plane; a lever pivotable relative to the housing assembly, the lever engaging a locking member to selectively lock or unlock the window/door, the lever having a locked position and an unlocked position, the lever being flush with or recessed behind the frontal plane of the housing assembly in both of the locked position and the unlocked position; a rocker received within the housing assembly and located behind the lever, the rocker being pivotable relative to the housing assembly between a first position and a second position, a movement of the rocker from the first position to the second position pushing the lever outwardly beyond the frontal plane of the housing assembly.

### CROSS REFERENCE TO RELATED APPLICATION

The present application claims the priority of U.S. Patent Application No. 63/713,736, filed on Oct. 30, 2024.

### TECHNICAL FIELD

The application relates generally to window hardware and, more particularly, to locking handle mechanisms for windows.

### BACKGROUND

A window, such as a house window, typically includes a frame secured to an opening defined through a wall and a window sash enclosing a glass panel. The window sash may be movable relative to the frame to selectively open or close the window. Typical casement windows includes a locking mechanism and an opening mechanism. The opening mechanism may include a handle rotatably mounted to the frame for opening and closing the window. Rotation of the handle engages an arm that exerts a force on the window sash to move the window sash relative to the frame. The locking mechanism may include a locking handle mounted to the frame, to lock the window in a closed position. Operation of the locking handle involves a locking member that engages a feature, such as a pin or notch, on the window sash to lock the window sash relative to the frame. Existing locking mechanisms are satisfactory to some extend, but there remain a need for improvements.

### SUMMARY

In one aspect, there is provided a locking mechanism for a window/door having a frame and a window/door sash, comprising: a housing assembly configured to be received in an opening defined by one of the frame and the window/door sash, the housing assembly having a frontal plane; a lever pivotable relative to the housing assembly, the lever engaging a locking member to selectively lock or unlock the window/door, the lever having a locked position and an unlocked position, the lever being substantially flush with or recessed behind the frontal plane of the housing assembly in both of the locked position and the unlocked position; a rocker received within the housing assembly and contacting an undersurface of the lever, the rocker being pivotable relative to the housing assembly between a first position and a second position, a movement of the rocker from the first position to the second position pushing the lever outwardly beyond the frontal plane of the housing assembly.

Still further in accordance with the aspect, for instance, the rocker has two rocker arms extending away from a pivot point, the rocker including interface surfaces at respective distal ends of the two rocker arms, each of the interface surfaces abutting the undersurface of the lever in a respective one of the first and second positions.

Still further in accordance with the aspect, for instance, the housing assembly includes a housing received in the opening and a cover mounted to the housing, the cover defining the frontal plane of the housing assembly and having a cover opening defined therethrough.

Still further in accordance with the aspect, for instance, the cover includes a front wall defining the frontal plane and the cover opening, the cover opening having a central section and two distal sections being wider than the central section, each of the two interface surfaces being in register with a respective one of the two distal sections of the opening.

Still further in accordance with the aspect, for instance, in both of the locked and unlocked positions of the rocker, one of the two interface surfaces protrudes beyond the frontal plane.

Still further in accordance with the aspect, for instance, the two rocker arms are non-parallel to one another.

Still further in accordance with the aspect, for instance, the pivot point is defined by an arcuate member, the two rocker arms protruding away from one another and away from the arcuate member, the arcuate member engaging a correspondingly-shaped arcuate recess defined by a rear wall of the housing assembly.

Still further in accordance with the aspect, for instance, the lever has a user-engageable arm and an engaging arm for engaging the locking member, the user-engageable arm connected to the engaging arm via a shaft such that the user-engageable arm and the engaging arm are offset from one another about a pivot axis defined by the shaft.

Still further in accordance with the aspect, for instance, the housing assembly includes a cover having an inner wall and a front wall, the inner wall protruding transversally from the front wall and defining a notch, the rocker including a rib defining an arcuate slot, the shaft engaged within both of the notch and the arcuate slot.

Still further in accordance with the aspect, for instance, the rocker is pivotable about a rocker axis being coaxial with the pivot axis of the lever.

Still further in accordance with the aspect, for instance, a bushing may be between the shaft and the notch and between the shaft and the arcuate slot.

Still further in accordance with the aspect, for instance, the rocker is pivotable about a rocker axis being coaxial with a pivot axis of the lever.

In accordance with another aspect, there is provided a method for locking a window or door, comprising: pressing on a rocker at a first end of a housing assembly to push a lever end of a lever out of the housing at a second end of the housing assembly; manipulating the lever end to rotate the lever about a pivot axis toward the first end of the housing assembly, the pivot axis being between the first end and the second end of the housing assembly; and pressing the lever end into the first end of the housing assembly to conceal the lever end into the housing assembly, and to expose the rocker at the second end of the housing assembly; whereby a rotation of the lever from the first end to the second end displaces a locking member locking the window or the door.

Further in accordance with the other aspect, for instance, pressing the lever end into the first end of the housing assembly causes the lever end to be generally flush with or recessed behind a frontal plane of the housing assembly.

Still further in accordance with the other aspect, for instance, pressing the lever end into the first end of the housing assembly causes the rocker to rotate.

Still further in accordance with the other aspect, for instance, pressing the lever end into the first end of the housing assembly causes the rocker to rotate about the pivot axis.

Still further in accordance with the other aspect, for instance, pressing the lever end into the first end of the housing assembly causes the rocker to have an interface surface thereof project outward of a frontal plane of the housing assembly.

Still further in accordance with the other aspect, for instance, pressing on the rocker at the first end of the housing assembly to push the lever end out of the housing at the second end of the housing assembly includes causing the lever end to move outward of a frontal plane of the housing assembly.

Still further in accordance with the other aspect, for instance, the method may further include: pressing on the rocker at the second end of the housing assembly to push the lever end out of the housing assembly at the first end of the housing assembly; manipulating the lever end to rotate the lever about the pivot axis toward the second end of the housing assembly; and pressing the lever end into the second end of the housing assembly to conceal the lever end into the housing assembly, and to expose the rocker at the first end of the housing assembly; whereby a rotation of the lever from the second end to the first end displaces a locking member unlocking the window or the door.

### BRIEF DESCRIPTION OF THE DRAWINGS

Reference is now made to the accompanying figures in which:

FIG. 1 is a partial three-dimensional view of a window in accordance with one embodiment;

FIG. 2 is a front view of a locking handle mechanism for the window of FIG. 1;

FIG. 3 is a side view of the locking handle mechanism of FIG. 2;

FIG. 4A is a three-dimensional exploded view of the locking handle mechanism of FIG. 2;

FIG. 4B is a three-dimensional exploded view of a variant of the locking handle mechanism of FIG. 2;

FIG. 5 is a side partially transparent view of the locking handle mechanism of FIG. 2;

FIGS. 6A to 6E are three-dimensional views of the locking handle mechanism of FIG. 2 illustrated in various positions; and

FIG. 7 is a three-dimensional view of the locking handle mechanism of FIG. 2 as part of a multi-point locking system.

### DETAILED DESCRIPTION

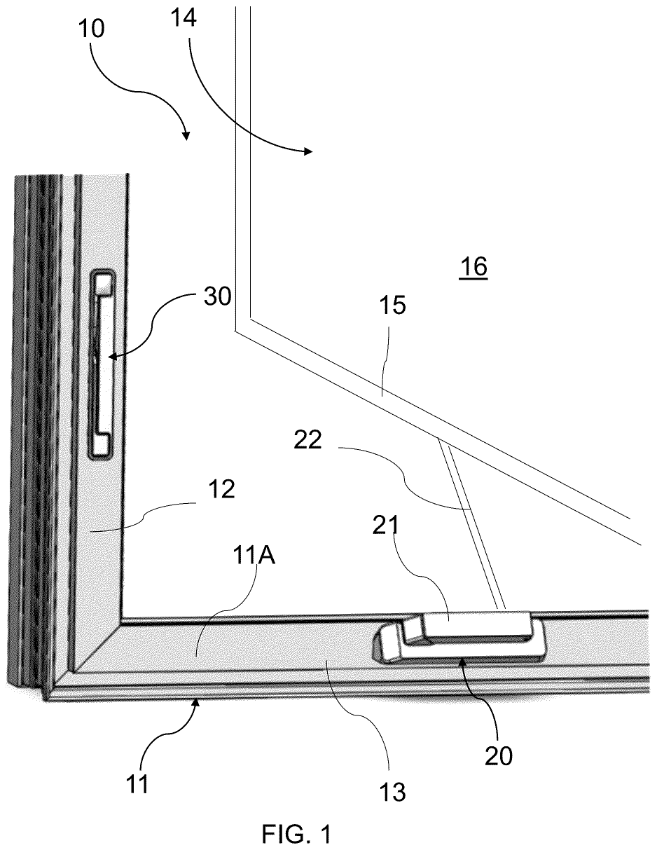

Referring to FIG. 1, a window is generally shown at 10 and includes a frame 11 having vertical frame members 12 (a.k.a., jambs) and horizontal frame members 13 (a.k.a., lintel, sill) extending transversally to the vertical frame members 12. The window 10 includes a window sash 14 pivotably mounted to the frame 11. In FIG. 1, the pivot axis of the window sash 14 is vertical, but it could also be horizontal, or at other orientations. In a variant, the window 10 has two or more window sashes 14 for a single frame 11, with for instance a mullion between the window sashes 14. The window sash 14 itself has a peripheral frame 15 enclosing a glass panel(s) 16, which may be an insulated glass unit. In a variant, a decorative grill may be present, or a structural grill supporting a plurality of small glass panel(s).

The window 10 includes an opening mechanism 20 and a locking handle mechanism 30, also referred to herein as a locking mechanism 30. The opening mechanism 20 is provided for opening and closing the window 10, i.e., enabling movement of the window sash 14 relative to the frame 11 to adjust a size of an opening between the window sash 14 and the frame 11. The opening mechanism 20 may also be referred to as an operator, as a casement mechanism, as a closing mechanism, as window actuator, among other names. The locking mechanism 30 may be used to lock the window in a closed position. In particular, the locking mechanism 30 may be used with a casement window (i.e., vertical pivot axis for the window sash 14) or with an awning window (i.e., horizontal pivot axis for the window sash 14), as examples among others. The locking mechanism 30 may also be used with doors, such as patio doors. For simplicity and consistency, the expressions “opening mechanism 20” and “locking mechanism 30” are used herein, although other expressions could be used to describe these devices.

The opening mechanism 20 includes a handle 21 engaged to an arm 22, through an appropriate mechanism of which the arm 22 is part of, the mechanism including links and pivots. The arm 22 is mounted to the window sash 14. The handle 21 is rotatable to move the arm 22 and the arm 22 exerts a force on the window sash 14 to open or close the window sash 14. The handle 21 is mounted to the frame 11 of the window 10. It may be mounted to one of the horizontal frame member 13. The opening mechanism 20 is briefly described according to one possible configuration. Other configurations are possible, including electrically powered one. The window 10 may be without an opening mechanism 20.

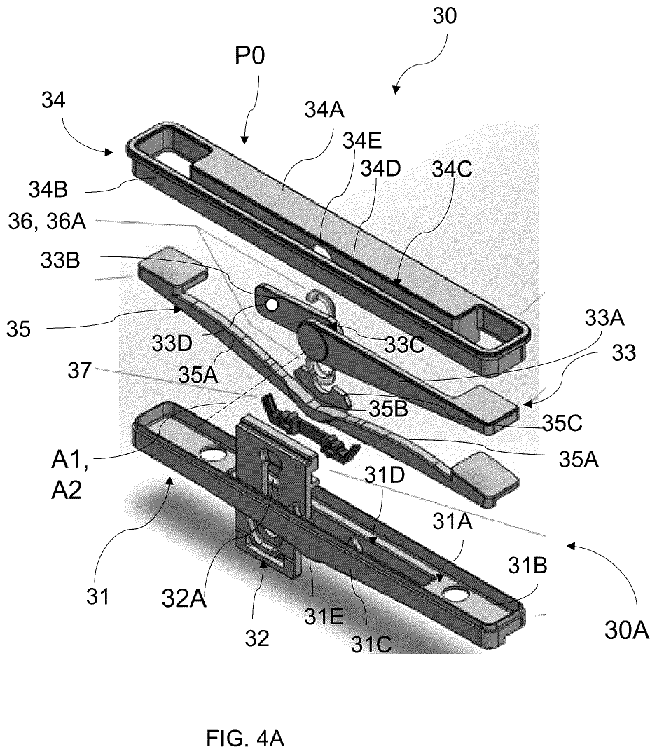

The locking mechanism 30 may be located on one of the vertical frame members 12 whereas the window sash 14 is pivotally mounted at or proximate the other of the vertical frame members 12. Understandably, the locking mechanism 30 may be located on one of the horizontal frame members 13. The locking mechanism 30 is configured to selectively lock or unlock the window sash 14 to the frame 11. In the embodiment shown, the locking mechanism 30 is designed to be generally flush to a face 11A of the frame 11. This may provide a more aesthetic look to the window 10. Stated differently, the face 11A may be said to lie in a plane of the frame 11 of the window 10, which plane may be substantially vertical for example. An exposed surface of the locking mechanism 30 may lie in the plane of the frame 11, or may be slightly raised relative to the plane of the frame 11 (e.g., at most 0.25 in), in which case a plane P0 of the exposed surface of the locking mechanism 30 may be vertical and/or may be parallel to the plane of the frame 11, which may be shown as PF (FIG. 3). As described below, the outwardmost point of the locking mechanism 30 relative to the plane PF may be the button 35E of the rocker 35.

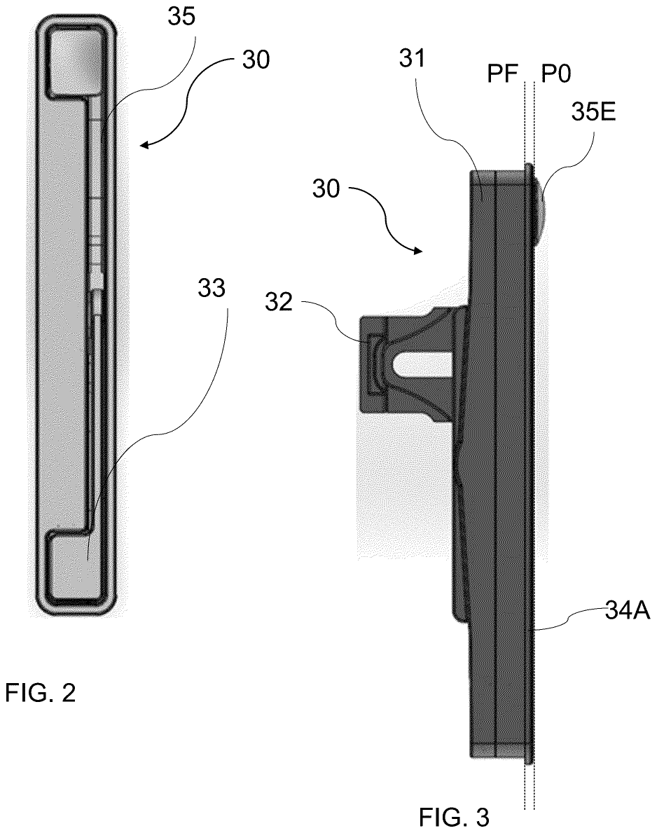

Referring to FIGS. 2-5, the locking mechanism 30 is described in more detail. The locking mechanism 30 includes a housing assembly 30A sized to be received into a correspondingly-shaped opening or like cavity, depression, receptacle defined by the frame 11. The housing assembly 30A has a main housing, referred to below simply as housing 31, having a substantially rectangular shape and defines an inner cavity 31A for accommodating other components of the locking mechanism 30. Other shapes are possible for the housing 31, and a housing per se is optional, as any structure acting as a support and defining space to receive components could be used. The inner cavity 31A of the housing 31 is optionally bounded by a rear wall(s) 31B and a peripheral wall(s) 31C extending all around a periphery of the rear wall 31B (if present). The peripheral wall(s) 31C may protrude transversally from the rear wall 31B. The housing 31 may define a slot 31D through the rear wall 31B. The slot 31D slidably receives a fork 32 or like catch that is used for selectively locking or unlocking the window sash 14. In the embodiment shown, the rear wall 31B defines an arcuate recess 31E whose function is described below. The catch 32 may engage a pin 32′ or like keeper secured to the frame 11 of the window 10 to lock the window sash 14 to the frame 11. Because item 32 is configured to engage the pin 32′, it is referred to as catch. However, as will be described below, item 32 may not be in direct contact with the keeper 32′. For example, in a multi-point locking system, item 32 transmits a translation movement to other components. Hence, item 32 may also be referred to as a locking member, as it is the part of the locking mechanism 30 that converts an action on a handle into a locking movement.

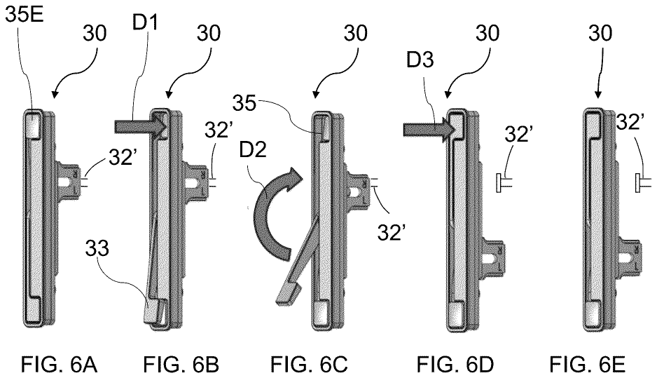

The locking mechanism 30 further includes a lever 33 pivotable relative to the housing 31 for rotation about a pivot axis A1. The lever 33 engages the catch 32 such that rotation of the lever 33 about the pivot axis A1 results into a translation of the catch 32 within the slot 31D. The lever 33 includes a user-engageable arm 33A and a catch-engaging arm 33B each extending away from the pivot axis A1 and away from one another, i.e., in opposite directions from the pivot axis A1. The catch-engaging arm 33B includes a pin 33D at or near its distal end. The pin 33D slidably engages a slot 32A of the catch 32. Therefore, a guide and follower is formed, with the movement of the pin 33D causing a translation of the catch 32 via its engagement into the slot 32A. More particularly, the pin 33D moves along an arcuate path as the lever 33 is rotated between its positions. The catch 32 is slidingly engaged to the housing 31 or other components and is limited to translation. Hence the pin 33D may move along the slot 32A, while imparting a pushing action on the catch 32 for the catch 32 to move in translation relative to the housing 31. In doing so, the catch 32 may move in and out of engagement with pin 32′ as observed in FIGS. 6A-6E. The catch 32 has engagement surface to serve as an abutment for the pin 32′. In the embodiment shown, the user-engageable arm 33A and the catch-engaging arm 33B are radially offset from one another about the pivot axis A1. A shaft 33C interconnects the user-engageable arm 33A and the fork-engaging arm 33B. The two arms may be parallel to one another, but axially offset from one another relative to the pivot axis A1. More detail about this configuration are presented below.

The housing assembly 30A of the locking mechanism 30 may optionally further include a cover 34 engageable to the housing 31. The housing assembly 30A defines a frontal plane P0, which is herein defined by the cover 34. More specifically, in this embodiment, the cover 34 has a front wall or front surface 34A and optionally a peripheral wall(s) 34B extending along a periphery of the front wall 34A and extending transversally therefrom. The frontal plane P0 may be defined by the front wall 34A of the cover 34. For simplicity, the expression “front wall” is used herein for 34A, even though in some instances 34A may be a surface or edge. In a variant, the cover 34's front most surface, which may be the front wall 34A or an edge surface, may be said to be generally flat, and may thus define a plane, referred to as the frontal plane P0. The front wall 34A may alternatively not be completely flat. In a variant in which the front wall 34A is not completely flat, the frontal plane P0 may be a virtual plane aligned with a front most point of the front wall 34A, and optionally parallel to a plane of the frame 11 when the locking mechanism 30 is installed on the frame 11. The frontal plane P0 may be parallel to the pivot axis A1. The frontal plane P0 faces away from the frame 11 of the window 10 and defines a visual part of the housing assembly 30A. If present, the peripheral wall(s) 34B of the cover 34 cooperates with the peripheral wall 31C of the housing 31 to enclose the inner cavity 31A of the housing 31. The two peripheral walls are thus disposed in an overlapping relationship. It will be appreciated that the peripheral wall 34B of the cover 34 and the peripheral wall 31C of the housing 31 may be replaced by clips or any means configured to interlock the cover 34 to the housing 31. It will also be appreciated that the cover 34 is used for aesthetic purposes and may be omitted in some configurations. That is, the housing assembly 30A may include a single component, such as the housing 31, that defines the frontal plane P0. The cover 34 is used to conceal hardware of the locking mechanism 30.

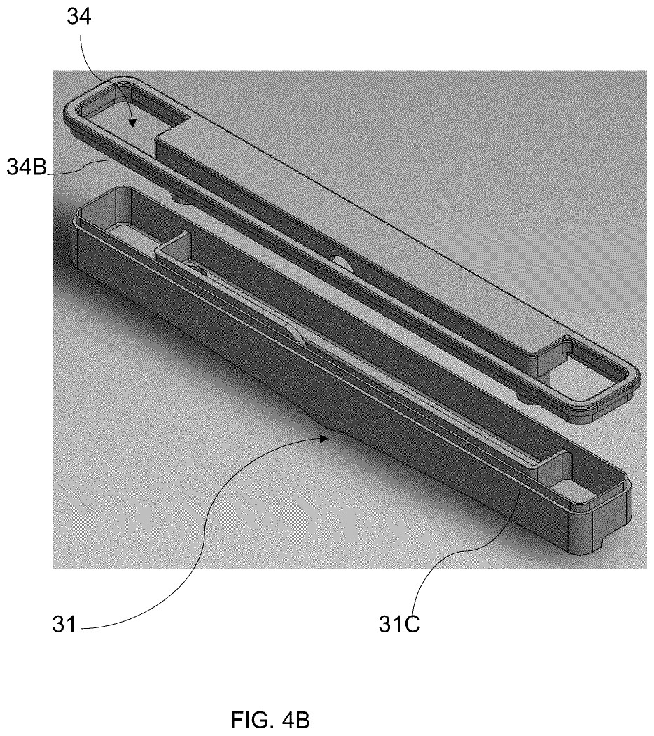

In the depicted embodiment, the cover 34 defines an opening 34C through the front wall 34A to receive the user-engageable arm 33A of the lever 33. A shape of the opening 34C may substantially match a shape of the lever 33. In this embodiment, the shape of the opening 34C includes a central section and two distal sections. A width of the central section, taken along the pivot axis A1, is less than the width of the two distal sections. The two distal sections are shaped to accommodate an end of the user-engageable arm 33A of the lever 33. The cover 34 may further define an inner wall 34D located between one or two longitudinal sections of the peripheral wall 34B, if present. The inner wall 34D extends along the central section of the opening 34C of the front wall 34A of the cover 34. The inner wall 34D defines a notch 34E having a substantially circular shape. This notch 34E is configured to mate with the shaft 33C of the lever 33, and may thus form part of a pivot with the shaft 33C, i.e., being a plain bearing. FIG. 4B shows an assembly of the housing 31 with the cover 34 with moving parts removed, with shapes of the housing 31 and cover 34 different than that assembly of the housing 31 and cover 34 of FIG. 4A. In particular, the peripheral wall 34B in FIG. 4B is shorter, while the peripheral wall 31C of the housing 31 is higher. It may be said that the height of the peripheral wall 31C (i.e., in a direction normal to plane P0) is at least equal to the height of the peripheral wall 34B. This is optional, but may facilitate the painting of the housing 31 and of the cover 34.

In the embodiment shown, the lever 33 is pivotable about the pivot axis A1 between a locked position and an unlocked position of the locking mechanism 30. In both of these two positions, the lever 33 may be said to be generally flush with or within the front wall 34A of the cover 34. More specifically, and as shown in FIG. 3, in both of the locked and unlocked positions, the lever 33 is substantially co-planar with the front wall 34A of the cover 34, and has its outermost surface at most in plane P0 (FIG. 3) though it may be slightly outward thereof, but not enough to be grasped. Herein, the expression “substantially” is meant to encompass slight deviations caused by, for instance, manufacturing tolerances and so on. The lever 33, in both of the locked and unlocked positions, is either flush or aligned with the front wall 34A of the cover 34 or recessed behind the front wall 34A. Put differently, the lever 33 is devoid of a substantial part protruding outwardly beyond the cover 34. As observed from FIG. 3, the lever 33 may not extend beyond the plane P0.

However, it may be difficult for a user to engage the lever 33 when it is in the locked or unlocked positions since there is no part the user may grab to move the lever 33. In the embodiment shown, the locking mechanism 30 further includes a rocker 35. The rocker 35 is engageable by the user to push the lever 33 until its distal end becomes accessible to the user.

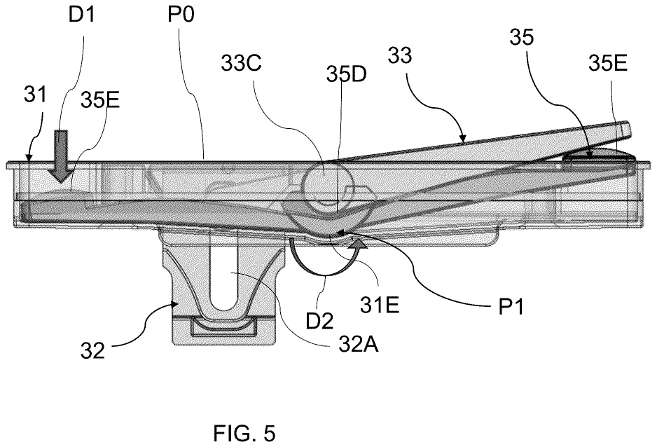

More specifically, the rocker 35 includes two rocker arms 35A joined together at a pivot P1 (FIG. 5) defined by an arcuate member 35B. The two rocker arms 35A extend away from one another and away from the pivot P1 and from the arcuate member 35B. In the embodiment shown, the two rocker arms 35A are non-parallel to one another. In other words, the rocker arms 35A define an angle different than 180 degrees between them. The arcuate member 35B is received within the arcuate recess 31E of the housing 31. The arcuate member 35B and the arcuate recess 31E are complementary shaped such that the arcuate member 35B slidably or pivotably engages the arcuate recess 31E. The rocker 35 may therefore “rock” or pivot about a rocker axis A2, which is parallel to the pivot axis A1. The rocker axis A2 and the pivot axis A1 are coaxial in this embodiment. For example, the arcuate member 35B may serve as a plain bearing for the shaft 33C as observed in FIG. 5, while the arcuate recess 31E serves as plain bearing for the arcuate member 35B. However, this need not be the case. In an alternate embodiment, the two rocker arms may be parallel to one another and the rear wall of the housing may define a bump, as one other possible pivot configuration. The pivot may thus be defined between the rocker and the bump.

In the embodiment shown, the rocker 35 includes a collar 35C secured to the arcuate member 35B, the collar 35C defines an arcuate slot 35D (FIG. 5). The arcuate slot 35D of the rocker 35 and the notch 34E of the cover 34 conjointly form a circular shape to enclose the shaft 33C of the lever 33, and hold it captive. A bushing 36 is optionally used to facilitate rotation of the lever 33. The bushing 36 includes two bushing segments 36A: one disposed against the notch 34E of the cover 34 and the other disposed against the arcuate slot 35D of the rocker 35. The bushing 36 may be a single segment with an opening through its periphery to receive the shaft 33C.

The rocker 35 further includes interfaces or interface surfaces, such as two buttons 35E at extremities of the rocker arms 35A. The buttons 35E are enlarged contact surfaces that may be pressed by a user. In a variant, the buttons 35E are in register with the two distal sections of the opening 34C of the cover 34. The buttons 35E thus have a peripheral shape corresponding to that of the distal sections of the opening 34C, so as to be snuggly received therein. In a variant, the interfaces of the rocker, e.g., the buttons 35E, come into contact with an underface (i.e., hidden face) of the end of the user-engageable arm 33A of the lever 33, as explained below. Accordingly, the buttons 35E may be convex. Moreover, as seen in FIG. 3, the convex shape of the button 35E may contribute to having the rocker 35 extend beyond the plane P0, and thus apparent to the user.

A biasing member(s) 37 is disposed between the rear wall 31B of the housing and the rocker 35, or operatively connected in any appropriate way to the rocker 35 to exert a biasing force on the rocker 35. The biasing member 37 is configured to exert a force on the catch 32 to oppose translation of the catch 32 between proximate ends of the slot 31D. The biasing member 37 includes two wings at its opposed ends. Each of the wings is abuttable against a respective inner wall defined by the cover 34.

Referring more particularly to FIG. 5, as illustrated, a force applied along direction D1 to one of the two buttons 35E of the rocker 35 pivots the rocker 35 about the rocker axis A2 along direction D2 thereby pushing the lever 33 out of the inner cavity 31A of the housing 31, by the other button 35E pressing on the underface of the lever 33 as observed, such that the lever 33 extends or protrudes beyond the plane P0 of the front wall 34A of the cover 34. Once the lever 33 is unseated from its locked or unlocked position, the biasing member 37 may push on the catch 32, which may exert a force on the lever 33 and push it further out of the housing 31. At that point, the user may have access to sufficient surface of the lever 33 to grab the distal end of the lever 33, which may be referred to as a finger-engageable section of the lever 33, to rotate the lever 33 about the pivot axis A1 to move the lever 33 in the other one of the locked or unlocked position.

Referring to FIGS. 6A to 6E, a sequence of operations to move the lever 33 from the locked position (FIG. 6A) to the unlocked position (FIG. 6E) is shown. The rocker 35 is movable between two positions, namely, a first position depicted in FIG. 6A and a second position depicted in FIGS. 6B-6E.

The lever 33 is shown in the locked position in FIG. 6A while the rocker 35 is in the first position. The lever 33 is in the locked position in that the catch 32 engages a pin 32′. As shown, the lever 33 is flush or concealed within the cover 34 (in a manner equivalent to FIG. 3) while a portion of one of the buttons 35E protrudes beyond a plane P0 of the cover 34 to invite a user to push on the button 35E. To make the lever 33 accessible, a user pushes along direction D1 on a visible one of the two buttons 35E of the rocker 35 since the other button 35E is hidden behind the lever 33. This causes the rocker 35 to pivot and raise the other button 35E to be raised thereby pushing on the lever 33 until it extends past the plane P0 of the cover 34. At that point, a user may grab the, now accessible, lever 33 and rotate it about the pivot axis A1 following direction D2. This results in a disengagement of the catch 32 from the pin 32′ whereby any locking caused by the locking mechanism 30 between window and frame is undone, i.e., the window is unlocked. The user may then conceal the lever 33 by pushing it along direction D3 until the lever 33 becomes flush with the front wall 34A of the cover 34, and lodged within the housing assembly 30A. At that point, the lever 33 is in the unlocked position as depicted in FIG. 6E, with the catch 32 separate from the pin 32′. When in FIG. 6E, a similar action may be taken but by pressing on the other button 35E of the rocker 35, to expose the lever 33 from its concealment in its unlocked position. The lever 33 may then be accessible for grasping to lock the locking mechanism 30. In this embodiment, pushing on one of the buttons 35E of the rocker 35 causes the lever 33 to pop out and positions the rocker 35 in the other of two positions. In other words, once the rocker 35 is solicited to move the lever 33, the rocker 35 moves from one of the first and second positions to the other of the first and second positions.

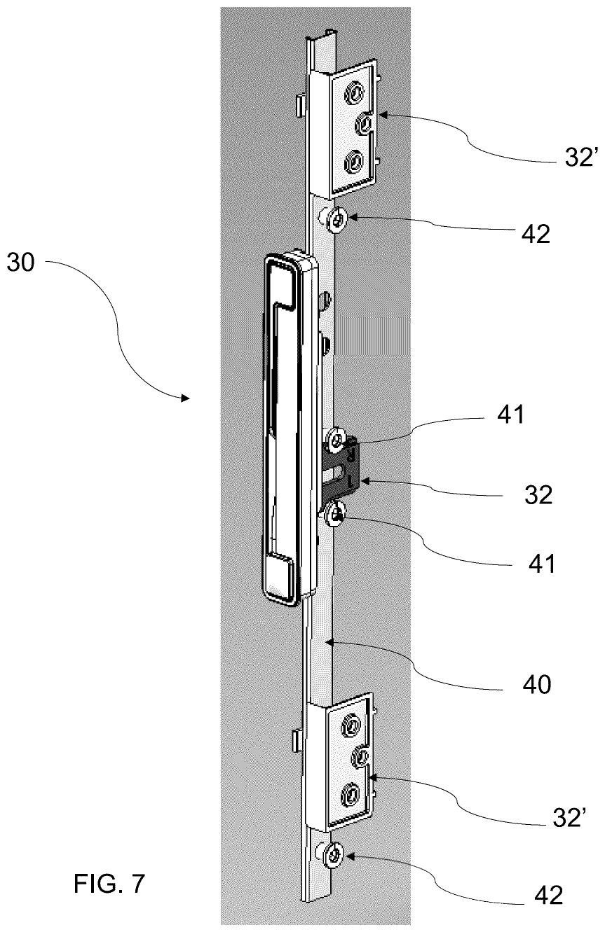

In the series of FIGS. 6A-6E, the locking mechanism 30 is shown as being used as part of a single point system, in that there is a single pin 32′ or equivalent keeper on the moving window sash or door. Referring to FIG. 7, the locking mechanism 30 is shown being used as part of a multi-point (i.e., multipoint) system, in which more than one keeper is present, as shown by way of the two keepers 32′. The keepers 32′ are illustrated as being brackets that may be fixed in any appropriate way to a window sash or door, as one possible type of keeper among many others. The multi-point system may include a bar 40 or like elongated member (e.g., rod) that is connected to a window or door frame, and that may translate along its length, as per an operative engagement with the catch 32 of the locking mechanism 30. For example, in FIG. 7, the catch 32 is between a pair of pins 41 on the bar 40, such that movement of the catch 32 in the manner described above results in a reciprocating movement of the bar 40. Other engagement may include a fastener between the bar 40 and the catch 32, as an option among many others. Additional pins shown as 42 may be at other locations along the bar 40. The additional pins 42 move with the bar 40 so as to have the capacity to be displaced to be face to face and in contact with the keepers 32′. In the illustrated embodiment in which the keepers 32′ are brackets, the brackets each define a surface that comes face to face with the pins 42 to block the opening of the window or door. The expression “pin” is used to describe items 41 and 42, but other names could be used, such as posts, abutments, etc. To facilitate movement, items 41, 42 may be rollers. This therefore constitutes an example of the locking mechanism 30 used as part of a multi-point locking system.

While reference is made hereinabove to a window, the locking mechanism 30 may be used with a door assembly, as an example among others. The door assembly may include a door (a.k.a., door panel, door sash) pivotally or translationally mounted to a door frame. Moreover, while FIG. 1 shows a casement window, other types of windows (e.g., awning window, guillotine) could use the locking mechanism 30.

Now that the locking mechanism 30 has been described, a method for locking a window or door is set forth. The method may include steps or sub-steps that may include: pressing on a rocker at a first end of a housing assembly to push a lever end of a lever out of the housing at a second end of the housing assembly; manipulating the lever end to rotate the lever about a pivot axis toward the first end of the housing assembly, the pivot axis being between the first end and the second end of the housing assembly; and pressing the lever end into the first end of the housing assembly to conceal the lever end into the housing assembly, and to expose the rocker at the second end of the housing assembly; whereby a rotation of the lever from the first end to the second end displaces a locking member locking the window or the door. In some variants, pressing the lever end into the first end of the housing assembly causes the lever end to be generally flush with or recessed behind a frontal plane of the housing assembly. In some variants, pressing the lever end into the first end of the housing assembly causes the rocker to rotate. In some variants, pressing the lever end into the first end of the housing assembly causes the rocker to rotate about the pivot axis. In some variants, pressing the lever end into the first end of the housing assembly causes the rocker to have an interface surface thereof project outward of a frontal plane of the housing assembly. In some variants, pressing on the rocker at the first end of the housing assembly to push the lever end out of the housing at the second end of the housing assembly includes causing the lever end to move outward of a frontal plane of the housing assembly.

A reserve movement may be performed to unlock the window or door. Accordingly, the method may include steps or sub-steps such as: pressing on the rocker at the second end of the housing assembly to push the lever end out of the housing assembly at the first end of the housing assembly; manipulating the lever end to rotate the lever about the pivot axis toward the second end of the housing assembly; and pressing the lever end into the second end of the housing assembly to conceal the lever end into the housing assembly, and to expose the rocker at the first end of the housing assembly; whereby a rotation of the lever from the second end to the first end displaces a locking member unlocking the window or the door.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A locking mechanism for a window/door having a frame and a window/door sash, comprising:
a housing assembly configured to be received in an opening defined by one of the frame and the window/door sash, the housing assembly having a frontal plane;
a lever pivotable relative to the housing assembly, the lever engaging a locking member to selectively lock or unlock the window/door, the lever having a locked position and an unlocked position, the lever being substantially flush with or recessed behind the frontal plane of the housing assembly in both of the locked position and the unlocked position;
a rocker received within the housing assembly and contacting an undersurface of the lever, the rocker being pivotable relative to the housing assembly between a first position and a second position, a movement of the rocker from the first position to the second position pushing the lever outwardly beyond the frontal plane of the housing assembly.

2. The locking mechanism of claim 1, wherein the rocker has two rocker arms extending away from a pivot point, the rocker including interface surfaces at respective distal ends of the two rocker arms, each of the interface surfaces abutting the undersurface of the lever in a respective one of the first and second positions.

3. The locking mechanism of claim 2, wherein the housing assembly includes a housing received in the opening and a cover mounted to the housing, the cover defining the frontal plane of the housing assembly and having a cover opening defined therethrough.

4. The locking mechanism of claim 3, wherein the cover includes a front wall defining the frontal plane and the cover opening, the cover opening having a central section and two distal sections being wider than the central section, each of the two interface surfaces being in register with a respective one of the two distal sections of the opening.

5. The locking mechanism of claim 2, wherein, in both of the locked and unlocked positions of the rocker, one of the two interface surfaces protrudes beyond the frontal plane.

6. The locking mechanism of claim 2, wherein the two rocker arms are non-parallel to one another.

7. The locking mechanism of claim 6, wherein the pivot point is defined by an arcuate member, the two rocker arms protruding away from one another and away from the arcuate member, the arcuate member engaging a correspondingly-shaped arcuate recess defined by a rear wall of the housing assembly.

8. The locking mechanism of claim 1, wherein the lever has a user-engageable arm and an engaging arm for engaging the locking member, the user-engageable arm connected to the engaging arm via a shaft such that the user-engageable arm and the engaging arm are offset from one another about a pivot axis defined by the shaft.

9. The locking mechanism of claim 8, wherein the housing assembly includes a cover having an inner wall and a front wall, the inner wall protruding transversally from the front wall and defining a notch, the rocker including a rib defining an arcuate slot, the shaft engaged within both of the notch and the arcuate slot.

10. The locking mechanism of claim 9, wherein the rocker is pivotable about a rocker axis being coaxial with the pivot axis of the lever.

11. The locking mechanism of claim 9, comprising a bushing between the shaft and the notch and between the shaft and the arcuate slot.

12. The locking mechanism of claim 1, wherein the rocker is pivotable about a rocker axis being coaxial with a pivot axis of the lever.

13. A method for locking a window or door, comprising:
pressing on a rocker at a first end of a housing assembly to push a lever end of a lever out of the housing at a second end of the housing assembly;
manipulating the lever end to rotate the lever about a pivot axis toward the first end of the housing assembly, the pivot axis being between the first end and the second end of the housing assembly; and
pressing the lever end into the first end of the housing assembly to conceal the lever end into the housing assembly, and to expose the rocker at the second end of the housing assembly;
whereby a rotation of the lever from the first end to the second end displaces a locking member locking the window or the door.

14. The method according to claim 13, wherein pressing the lever end into the first end of the housing assembly causes the lever end to be generally flush with or recessed behind a frontal plane of the housing assembly.

15. The method according to claim 13, wherein pressing the lever end into the first end of the housing assembly causes the rocker to rotate.

16. The method according to claim 15, wherein pressing the lever end into the first end of the housing assembly causes the rocker to rotate about the pivot axis.

17. The method according to claim 13, wherein pressing the lever end into the first end of the housing assembly causes the rocker to have an interface surface thereof project outward of a frontal plane of the housing assembly.

18. The method according to claim 13, wherein pressing on the rocker at the first end of the housing assembly to push the lever end out of the housing at the second end of the housing assembly includes causing the lever end to move outward of a frontal plane of the housing assembly.

19. The method according to claim 13, further including:
pressing on the rocker at the second end of the housing assembly to push the lever end out of the housing assembly at the first end of the housing assembly;
manipulating the lever end to rotate the lever about the pivot axis toward the second end of the housing assembly; and
pressing the lever end into the second end of the housing assembly to conceal the lever end into the housing assembly, and to expose the rocker at the first end of the housing assembly; whereby a rotation of the lever from the second end to the first end displaces a locking member unlocking the window or the door.
